(19) United States
(12) Patent Application Publication
(10) Pub. No.: US 2007/0242267 A1
(43) Pub. Date: Oct. 18, 2007

(54) Optical Focusing Devices

(75) Inventors: Tongxin Lu, San Jose, CA (US); Xiaohan Wang, Alameda, CA (US)

Correspondence Address: EMIL CHANG;LAW OFFICES OF EMIL CHANG, 874 JASMINE DRIVE, SUNNYDALE, CA, 94086, US

(73) Assignee: Raintree Scientific Instruments (Shanghai) Corporation, Sunnyvale, CA (US)

(21) Appl. No.: 11/735,979

(22) Filed: Apr. 16, 2007

Related U.S. Application Data
(60) Provisional application No. 60/791,952, filed on Apr. 14, 2006.

(51) Int. Cl. G01J 3/40

(52) U.S. Cl. 356/302

(57) ABSTRACT

The present invention discloses an optical measurement and/or inspection device that, in one application, may be used for inspection of semiconductor devices. It comprises a light source for providing light rays; a half-parabolic-shaped reflector having an inner reflecting surface, where the reflector having a focal point and an axis of summary, and a device-under-test is disposed thereabout the focal point. The light rays coming into the reflector that is in-parallel with the axis of summary would be directed to the focal point and reflect off said device-under-test and generate information indicative of said device-under-test, and then the reflected light rays exit said reflector. A detector receives the exited light rays and the light rays can be analyzed to determine the characteristics of the device-under-test.

### PRIORITY CLAIM

This application claims priority from a provisional patent application entitled “Optical Focusing Device” filed on Apr. 14, 2006, having an application No. 60/791,952. This application is incorporated herein by reference in its entirety.

### FIELD OF THE INVENTION

The present invention relates to the inspection and measurement systems, and in particular, to optical inspection and measurement of devices under test such as semiconductor devices and/or wafers.

### BACKGROUND

Information created by directing a beam of light to reflect off a device-under-test (“DUT”) has a variety of uses. The thickness of the various coatings (either single layer or multiple layers) on the wafer can be determined from a reflectance or relative reflectance spectrum. Also, the reflectance at a single wavelength can be extracted. This is useful where the reflectance of photoresist coated wafers at the wavelength of lithographic exposure tools must be found to determine proper exposure levels for the wafers, or to optimize the thickness of the resist to minimize reflectance of the entire coating stack. The refractive index of the coating can also be determined by analysis of an accurately measured reflectance spectrum.

It is especially useful, for a variety of industrial applications, to measure the thickness of a very thin film (less than about 300 angstroms in thickness) on a sample, by reflectance measurements of the sample under a microscope. For example, the sample can be a semiconductor wafer, and the very thin film can be coated on a silicon substrate of the wafer.

Because of the tight tolerance requirements typically required in the semiconductor arts, an accurate means for obtaining reflectance measurements of a wafer is needed. In conventional reflectance measurement systems, monochromatic or broadband radiation is reflected from the wafer, and the reflected radiation is collected and measured. For example, referring to FIG. 1, in a traditional measurement and/or inspection system, a lens 100 is used where incoming rays 102 refract through the lens 100 and is focused 104 on the DUT 106 and create reflectance information that can be analyzed.

High numerical aperture (“NA”) lens (NA˜0.95) has been used to achieve simultaneous wide range of angle of incidence and angle of azimuth. However it has many limitations. First, it is very difficult to extend the wavelength to UV (e.g. below 400 nm) due to material absorption at UV wavelength. Second, it is very difficult to work with wide broadband radiation, such as from 250 nm to 1000 nm simultaneously due to chromatic aberration. Thirdly, as light passes through the lens, there is the issue of the absorption of light where the intensity of the light is diminished as it passes through the lens. Fourthly, as light passes through a lens, the refraction of the light as it passes through the lens is also an issue since the quality of the lens becomes highly critical in order to have good refraction of the light.

To achieve consistent performance with broadband radiation, a reflective optics is required. Due to its limited number of variables, the design choices are also limited. For example, the reflective objective of Schwarzchild design has limited NA and central beam obstruction. It can not achieve wide range of angle of incidence. Aspherical reflective surfaces are also widely used. However it is mostly used in very traditional fashion, i.e. the axis of symmetry is perpendicular to the surface. The range of angle of incidence is also limited.

Therefore, it is desirable in optical measurement and inspection systems that the optical beam can incident on the object from different incidence angles or different azimuth angles. It is further desirable that the beam is of multiple wavelengths or continues broadband radiation.

### SUMMARY OF THE INVENTION

An object of the present invention is to provide methods and devices that can achieve wide angle of incidence range (0 degree to 90 degree) with reflective surfaces.

Another object of this invention is to provide methods and devices that can simultaneously inspect and/or measure a large device-under-test.

Briefly, the present invention discloses an optical measurement device, comprising of: a light source for providing light rays; a half-parabolic-shaped reflector having an inner reflecting surface, wherein said reflector having a focal point and an axis of summary, and a device-under-test is disposed thereabout the focal point; wherein the light rays coming into the reflector that is in-parallel with the axis of summary would be directed to the focal point and reflect off said device-under-test and generate information indicative of said device-under-test; wherein said reflected light rays exit said reflector; and a detector for receiving the exited light rays.

An advantage of the present invention is that it provides methods and devices that can achieve wide angle of incidence range (0 degree to 90 degree) with reflective surfaces.

Another advantage of the present invention is that it provides methods and devices that can simultaneously inspect and/or measure a large device-under-test.

### DRAWINGS

The following are further descriptions of the invention with reference to figures and examples of their applications.

FIG. 1 is an illustration of a prior art technology for focusing a light beam using lenses for inspection and/or measurement systems;

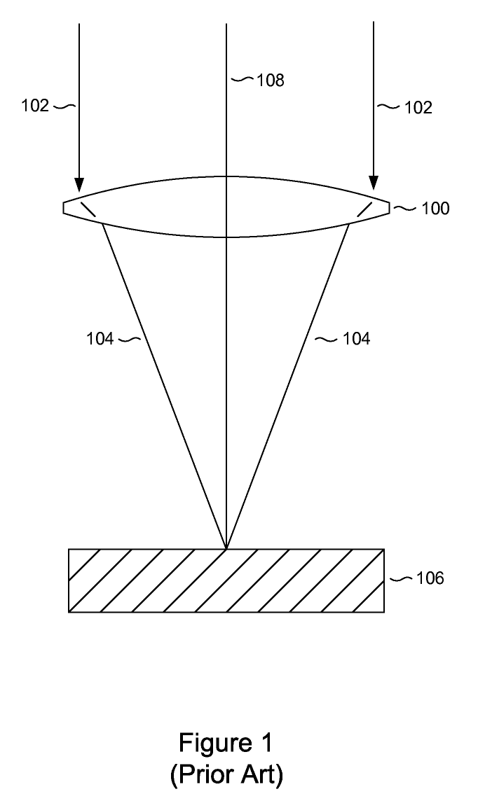

FIG. 2 is a two-dimensional conceptual illustration of the technology of the present invention;

FIG. 3 is a three-dimensional top-side view of a preferred embodiment of the present invention;

FIG. 4 is a view into the parabolic reflector of the present invention;

FIG. 5 is side view of the parabolic reflector of the present invention;

FIG. 6 is a top view of a parabolic reflector of the present invention;

FIG. 7 is another embodiment of the present invention where the light source is placed at the focal point of the parabolic reflector; and

FIG. 8 is another embodiment of the present invention where the light detector is placed at the focal point of the parabolic reflector.

### DETAILED DESCRIPTIONS OF THE PREFERRED EMBODIMENTS

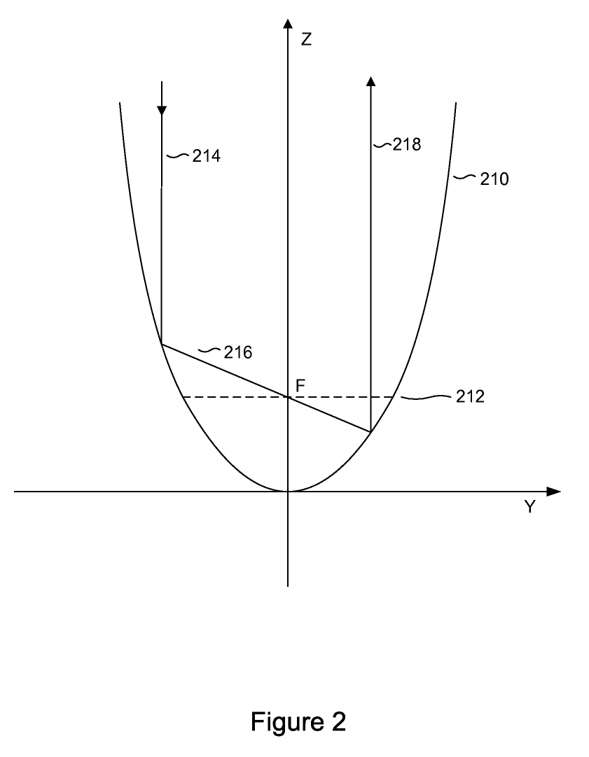

Referring to FIG. 2, a key underlying concept of the embodiments of the present invention is explained. Given a parabola 210 disposed on a y-axis and a z-axis, conceptually, the shape of the parabola can be described be a simple mathematical function, z=ay², where incoming rays parallel to the z-axis would intersect the z-axis at its focal point “F”, where the focal point is at (0, ¼a), and “a” is a constant. The incoming ray intersects the parabolic surface and it is redirected towards the focal point at the incident plane 212 (the plane that is perpendicular to the axis of symmetry and passes through the focal point, “F”).

Here, as shown, the incidental incoming light ray 214 is parallel to the axis of symmetry. The ray hits the parabolic surface and the parabolic reflector, by virtue of its properties, directs the beam towards its focal point and intersects the z-axis at intersection point “F”. After the intersection, the ray hits the parabolic surface again, and the parabolic surface re-directs the ray 218 back toward its incident direction parallel to the axis of symmetry. Due to the unique characteristic of the paraboloid, reflected ray will be always be parallel to the axis of symmetry if the incoming ray is parallel to the axis of symmetry.

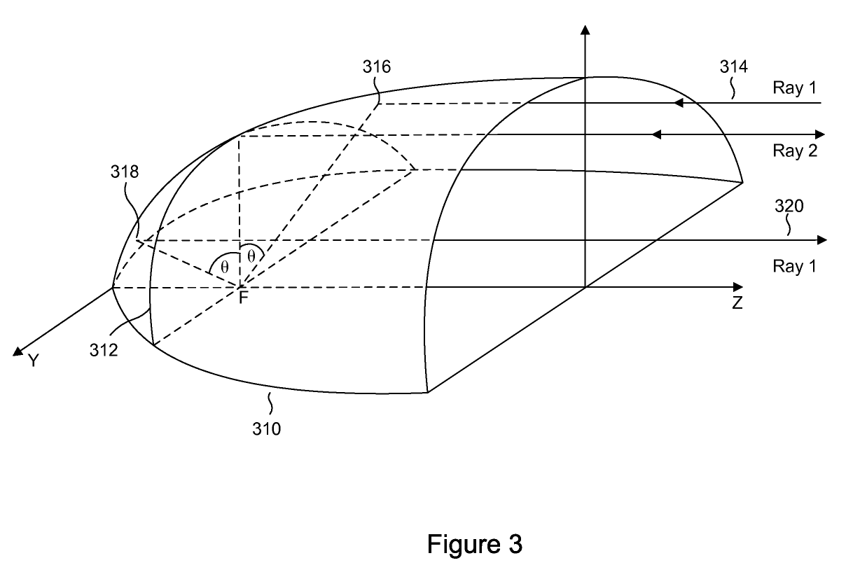

In a presently preferred embodiment of the present invention, referring to FIG. 3, a parabolic reflector 310, which can be in the shape of a half-paraboloid is illustrated. Here, the properties described above for two-dimensional parabolic shapes would hold as well. For example, an incoming ray 314, ray 1, that is coming in parallel to the axis of summary, would reflect off the parabolic surface at 316. The reflected ray would, due to the characteristics of the paraboloid, be directed to the focal point of the paraboloid, point “F”, which is also the point of intersection between the intersection plane 312 and the z-axis, the axis of summary. The ray would reflect off point “F”, create information with respect to the DUT (not shown) and again reflect off a point off the parabolic surface 318 and be re-directed out 320 of the parabolic reflector, which would be read by a detector (not shown). Again, due to the unique characteristic of the paraboloid, reflected ray will be always parallel to the axis of symmetry if the incoming ray is parallel to the axis of symmetry.

The shape of the embodiments of the present invention can be a paraboloid, which can be manufactured by rotating a parabolic curve around its axis of symmetry. The reflector can be made by cutting the paraboloid in two halves along its axis of rotation. In actual use, the preferred embodiment of the present invention can be slightly less than one-half of the paraboloid such that the axis of symmetry of the paraboloid can be located on the surface of the DUT to be measured or inspected. The inner surface of the parabolic reflector would be reflective.

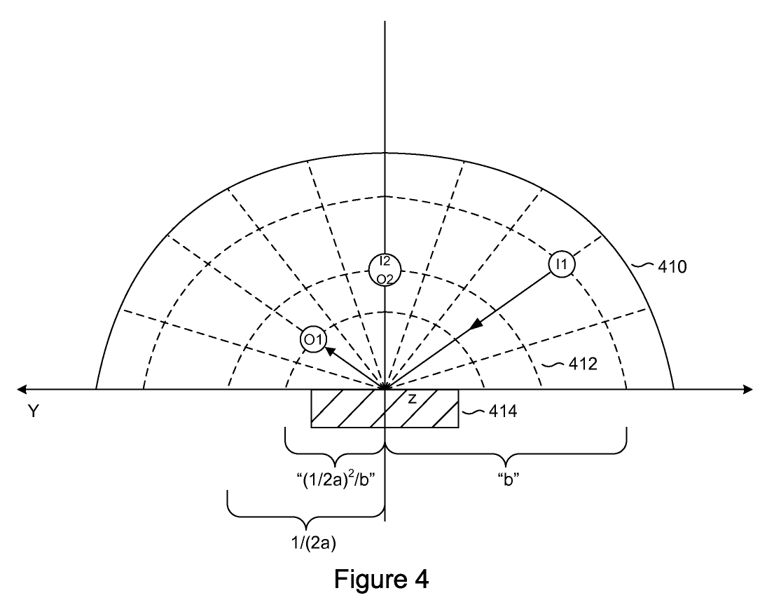

Depending on where the ray intersects the parabolic surface, the ray will intersect the flat surface at different incident and azimuth angles. The relationship between the intersection point on the parabolic surface and the ray angle can be easily calculated. Referring to FIG. 4, in looking into the opening of the parabolic reflector, if we look toward the reflected beam, the parabolic reflector looks like a half hemisphere. Let's image there is a polar coordinates at the end surface of the reflector, the cross-section of incoming beam is a quarter of circle, and the cross-section of the reflected beam is also quarter of circle.

The rays incoming at radius of 1/(2a) will also exit the at the same radius (see incoming ray 1 “I1” and outgoing ray 1 “O1”). It is also easy to show that any incoming ray intersects that parabolic surface at a distance from the axis of symmetry of “b”, then the exit ray will intersect the parabolic surface at a distance of (½a)²/b. The angle measured at plane of incidence will be same. So, in polar coordinate (ρ, θ), if the incoming ray has coordinates (ρ, θ), the exit ray will have coordinates of (r²/ρ, π-2θ), where r 1/(2a). A ray, such as ray 2 (“I2” and “O2”) coming in parallel with the z-axis would also exit parallel with the z-axis.

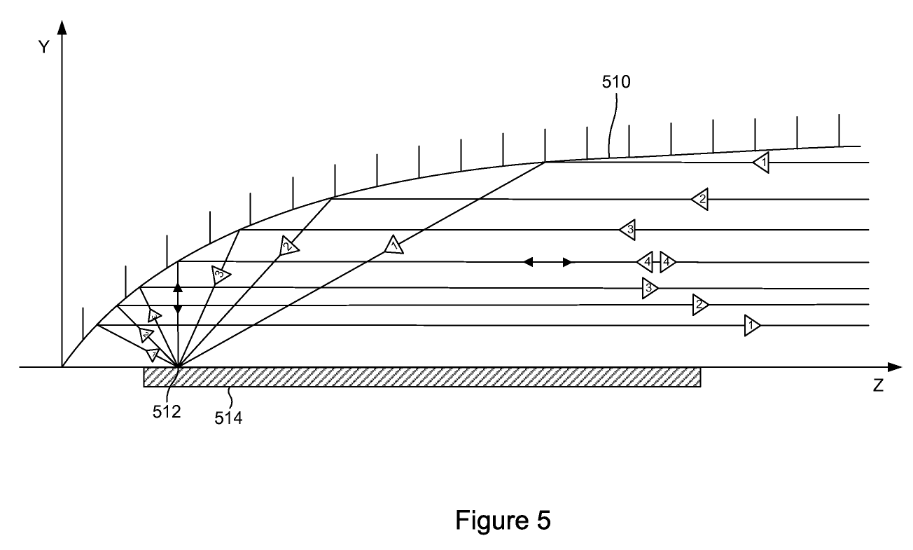

Referring to FIG. 5, a side view of the reflector 510 is illustrated. Here, the focal point (0, ¼a) is at 512, and the DUT can be fairly large when compared to traditional inspection systems. Here, Rays 1, 2, 3 and 4 are coming in parallel with the z-axis, and, as illustrated, after hitting the DUT, the rays are re-directed and reflect off the reflector and re-directed out of the reflector.

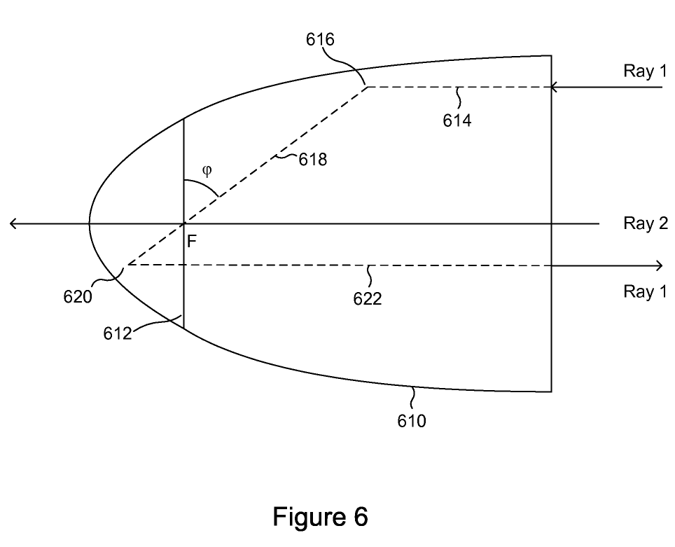

Referring to FIG. 6, a top view of the reflector 610 is illustrated with a plane of incidence 612 and azimuth angle φ. Here, ray 1 comes in 614 parallel to the z-axis and reflects off a point 616 off the reflector and is re-directed 618 to the focal point of the reflector. It then reflects off the DUT (not shown) and again it reflects off the reflector at 620 and exits the reflector parallel to the z-axis 622. Ray 2 enters along and parallel to the z-axis and exits along the same path.

The exiting rays, since it has been reflected off the device-under-test, their characteristics would provide information indicative of the device-under-test. The reflected light rays would be collected by a detecting device and analysis of the reflected light rays would then be conducted. The detecting device can be any type depending the nature of the inspection work or measurement work.

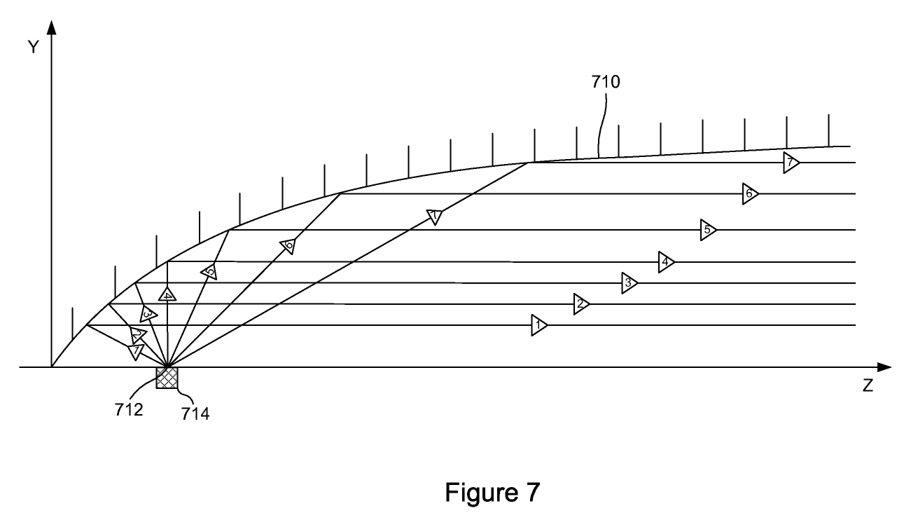

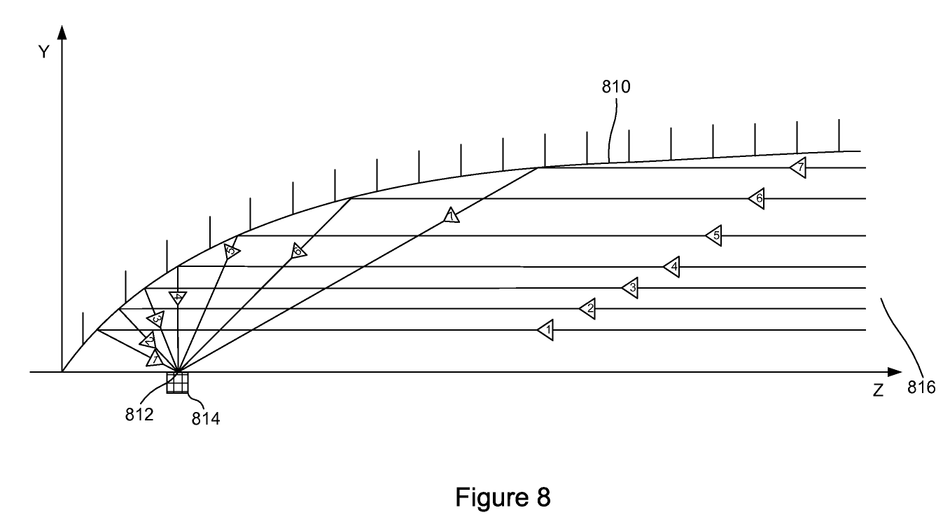

Referring to FIG. 7, in yet another embodiment of the present invention, a light source 714 can be place at the focal point 712, resulting in light emitting from the focal point and be re-directed to generate collimating beams in exiting the reflector. Referring to FIG. 8, in yet another embodiment of the present invention, a light detector 814 can be placed at the focal point 812 to collect light beams coming into the reflector. In yet another embodiment, a light source can be placed at the focal point (see FIG. 7) and a detector can be placed at the focal point (see FIG. 8) as well to collect any light reflected from any DUT, where the DUT can be placed at the opening of the reflector (not shown 816). Alternately, the light detector can be placed at the back of the reflector to collect the collimating beams.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. An optical device, comprising:
a light source for providing incoming light rays;
a half parabolic-shaped reflector having a reflecting surface and a focus point for focusing incoming light rays on a device-under-test, wherein the incoming light rays reflect off from the device-under-test and wherein the reflected light rays provides information indicative of the device-under-test; and
a detecting device for collecting the reflected light rays reflected off from said device-under-test.

2. The device of claim 1 wherein said reflector having an axis of summary and the device-under-test is disposed thereabout.

3. The device of claim 2 wherein incoming light rays that are parallel to the axis of summary is directed to the focal point of the reflector and thereby to the device-under-test.

4. The device of claim 2 wherein the shape of the reflector is less than a half-paraboloid.

5. An optical measurement device, comprising:
a light source for providing light rays;
a half-parabolic-shaped reflector having an inner reflecting surface, wherein said reflector having a focal point and an axis of summary, and a device-under-test is disposed thereabout the focal point; wherein the light rays coming into the reflector that is in-parallel with the axis of summary would be directed to the focal point and reflect off said device-under-test and generate information indicative of said device-under-test; wherein said reflected light rays exit said reflector; and
a detector for receiving the reflected light rays.

6. An optical device, comprising:
a light source for providing light rays;
a half parabolic-shaped reflector having a reflecting surface and a focus point, wherein said light source is placed at the focal point and light rays is reflected off the reflecting surface becoming collimating beams and reflecting off a device-under-test at the opening of the reflector, wherein the reflected light rays provides information indicative of the device-under-test; and
a detecting device for collecting the reflected light rays reflected off from saiddevice-under-test.

7. The device of claim 6 wherein said detecting device is placed at the focal point.

8. The device of claim 6 wherein the shape of the reflector is less than a half-paraboloid.
